(19) United States
(12) Patent Application Publication
(10) Pub. No.: US 2010/0039434 A1
(43) Pub. Date: Feb. 18, 2010

(54) Data Visualization Using Computer-Animated Figure Movement

(76) Inventor: Babak Makkinejad, Troy, MI (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/191,816

(22) Filed: Aug. 14, 2008

(51) Int. Cl. G06T 13/00

(52) U.S. Cl. 345/473

(57) ABSTRACT

Methods, systems, and apparatus, including medium-encoded computer program products, can provide data visualization using computer animated figure movement. A computer animated figure is associated with a data stream. A set of movements to be performed by the computer animated figure in response to one or more data characteristics of the data stream is assigned. The data stream is received and processed to determine the one or more data characteristics. The computer animated figure is animated according to the assigned set of movements in response to determining the one or more data characteristics.

### TECHNICAL FIELD

The subject matter disclosed in this specification relates to data processing and analysis, and more particularly to data visualization using computer animated figure movement.

### BACKGROUND

Dance notation is historically used to choreograph and document classic dance sequences. It has also been used in dance instruction for analysis and reconstruction of body movements. Many different forms of dance notation have been created. Two systems used in Western culture are Labanotation (also known in Europe as Kinetography Laban) and Benesh Movement Notation. Eshkol-Wachman Movement Notation and the Sutton Movement system, which includes DanceWriting, are also used.

Labanotation, or Kinetography Laban, is a system of movement notation that is also used for dance notation. Invented by Rudolf Laban, it uses abstract symbols to define the: direction of the movement; part of the body doing the movement; level of the movement; and length of time it takes to do the movement. The shapes of the symbols indicate nine different directions in space and the shading of the symbol specifies the level of the movement.

The International Movement Writing Alphabet (the IMWA) is an ordered set of symbols used to record movement, developed by Valerie Sutton. It was originally designated Suttons's Sign Symbol Sequence. The IMWA is used in the Sutton Movement System's MovementWriting, which consists of five subdivisions: SignWriting, for writing the movements of Sign Languages; DanceWriting, for writing dance choreography; MimeWriting, for writing classic mime; SportsWriting, for writing ice skating and gymnastics routines; and MovementWriting, for writing all gestures.

Computerized dance notation systems relatively recently have been used to choreograph computer animated figures. One of the early dance notation systems for computer animation was the DOM dance notation system, created by Eddie Dombrower on the Apple II personal computer in 1982.

### SUMMARY

This specification describes technologies relating to data visualization using computer animated figure movement.

In general, one aspect of the subject matter described in this specification can be embodied in a method that includes associating a computer animated figure with a data stream. A set of movements to be performed by the computer animated figure in response to one or more data characteristics of the data stream is assigned. The data stream is received. The data stream is processed to identify data characteristics in the data stream. The computer animated figure is animated according to the assigned set of movements in response to the identified data characteristics. Other embodiments of this aspect include corresponding systems, apparatus, and computer program products.

These and other embodiments can optionally include one or more of the following features. The set of movements can include a set of dance movements and assigning the set of movements can include assigning the set of dance movements using a dance notation system. Assigning a set of movements can include assigning the set of movements using a movement notation system. The movement notation system can include a Labanotation system, a Sutton Movement system or any other suitable dance and movement notation system that is amenable to processing by a digital computing device.

The one or more data characteristics can include one or more statistical properties associated with at least a portion of the data stream, the one or more statistical properties can include a mean, a standard deviation, a variance, a kurtosis, a skewness, a maximum, and/or a minimum. Assigning a set of movements can include assigning a set of movements to be performed by the computer animated figure in response to a first statistical property of the one or more statistical properties exceeding a predetermined threshold or falling below that threshold. Identifying data characteristics in the data stream can include processing the data stream to determine whether the first statistical property exceeds the predetermined threshold or falls below that threshold. Animating the computer animated figure can include animating a computer animated figure according to the assigned set of movements in response to determining that the first statistical property exceeds or falls below a predetermined threshold.

The one or more data characteristics can include data values in the data stream. Assigning a set of movements can include assigning a set of movements to be performed by the computer animated figure in response to the data values. Identifying data characteristics can include processing the data stream to determine the data values. Animating the computer animated figure can include animating a computer animated figure according to the assigned set of movements in response to the data values. Animating the computer animated figure can also include modifying a speed associated with movements of the computer animated figure in response to changes in the data values.

The data stream can include a first and second data stream, and the computer animated figure can include multiple limbs. The embodiments can also include assigning a first set of movements of a first set of limbs to be performed by the computer animated figure in response to one or more data characteristics of the first data stream. A second set of movements of a second set of limbs can be performed by the computer animated figure in response to one or more data characteristics of a second data stream. The first and second data streams can be received and processed to identify the data characteristics of the first and second data streams. The first and second sets of limbs can be animated according to the assigned first set of movements in response the identified data characteristics of the first and second data streams. These data characteristics may include the statistical properties of each stream as well as any statistical relationships that may obtain among these streams, e.g. statistical correlations.

The data stream can include a first data stream, and the computer animated figure can include a first computer animated figure. The embodiments can also include assigning a second set of movements to be performed by the second computer animated figure in response to one or more data characteristics of the second data stream. The first and second data streams can be received and processed to identify the data characteristics of the first and second data streams. The second computer animated figure can be animated according to the assigned second set of movements in response to the identified data characteristics of the second data stream. The embodiments can also include determining a correlation between the first data stream and the second data stream; associating a spatial relationship between the first computer animated figure and the second computer animated figure corresponding to that correlation; and animating the first computer animated figure and the second computer animated figure in accordance with the spatial relationship. The first data stream and the second data stream can be highly correlated, and the spatial relationship can include the first computer animated figure moving in relatively close proximity to the second computer animated figure, and/or the first computer figure moving with approximately the same rhythm as the second computer figure.

The embodiments can also include providing a user interface. The user interface can operate to accept input from a user to perform the following actions: select the data stream for visualization; receive an identification of the data characteristics; create the computer animated figure; associate the computer animated figure with the data stream; identify the set of movements using a movement notation system; and choreograph the computer animated figure by associating the one or more data characteristics with the set of movements.

The details of one or more embodiments of the invention are set forth in the accompanying drawings and the description below. In this manner, data can be presented in a more concise, compelling and aesthetically pleasing manner. Data monitoring, mining, and analysis can be made more enjoyable and more engaging, which can result in increased productivity and morale for the data observers and potentially increased revenues for their employers. These and other advantages may not apply to all embodiments. Other features, objects, and advantages of the invention will be apparent from the description and drawings, and from the claims.

### DESCRIPTION OF DRAWINGS

FIG. 1 is an overview of a system for data visualization using computer animated figure movement.

FIG. 2 is a block diagram of a data visualization system.

FIG. 3A is a flowchart of a process for data visualization using computer animated figure movement.

FIG. 3B is a flowchart of a process for visualizing two data streams using two limbs of a computer animated figure.

FIG. 3C is a flowchart of a process for visualizing two data streams using two computer animated figures.

FIG. 3D is a flowchart of a process for choreographing a computer animated figure for visualizing a data stream.

FIG. 4A is an example association showing a computer animated figure that is animated in response to a single multivariate data stream.

FIG. 4B is an example association showing a computer animated figure with multiple limbs moving in response to multiple data streams.

FIG. 4C is an example association showing multiple computer animated figures being animated in response to multiple data streams.

Like reference symbols in the various drawings indicate like elements.

### DETAILED DESCRIPTION

For ages, dance has been used to express or communicate stories, emotions, and ideas through various physical movements and gestures. Often dances are choreographed before being performed for the intended observers. Movements, particularly choreographed dance movements, can be used to animate a computer generated figure in order to communicate to a user information about one or more data streams. A data stream is a series of continuous or discrete data, which is typically a function of one or more parameters (parameterized data), that can be gathered from sensors, from business transactions, from scientific studies, from marketing studies, and a host of other sources.

In general, a system can be configured to trigger certain movements of a computer animated figure in response to the characteristics of the data contained in a data stream. Various characteristics of virtually any type of data or data stream can be visualized utilizing virtually any dance movements or other type of movements or gestures. For example, a data stream can contain various temperatures measured by a thermometer over time or can contain measurements of the utilization of a central processing unit (CPU) as a function of the volume of data processed. A figure can be animated to “fouetté-en-tournant” when the running average of the temperature exceeds a certain threshold or to perform a “moonwalk” when the CPU utilization hits its maximum. Other attributes of movement, in addition to the type or form of the movement, can be used to visualize a data stream, such as the speed between successive movements or the intensity of those movements.

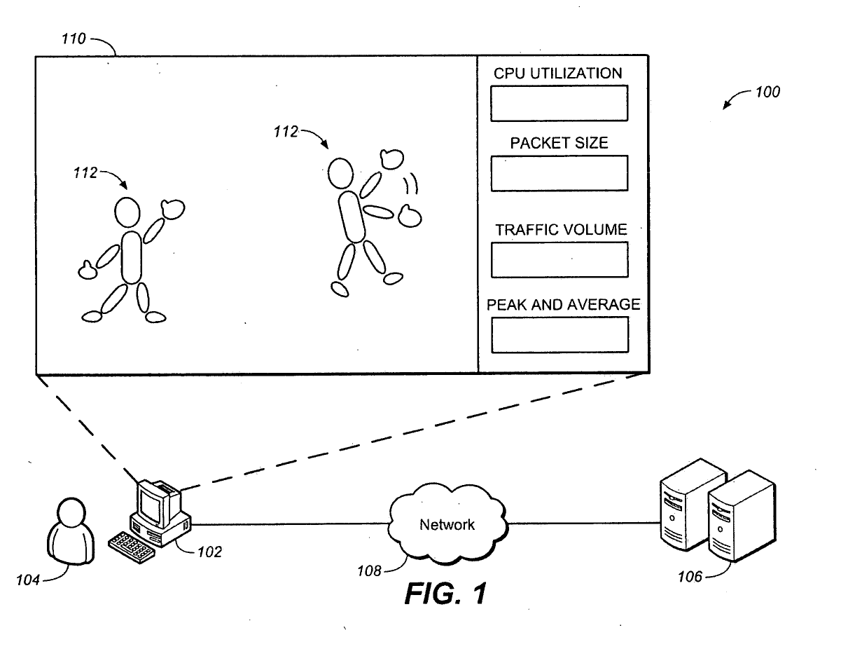

FIG. 1 is an overview of a system 100 for data visualization using computer animated figure movement. In general, a data visualization computer 102 can receive configuration information from a user 104 that associates movements of computer animated figures with characteristics of data in a data stream. The data visualization computer 102 can receive the data streams from data sources 106 via network 108. Alternatively, the data source may be some data storage media such as a computer disk-drive, CD, DVD, Solid-State memory or some such. The data visualization computer 102 can process the retrieved data streams to determine the characteristics of the data in the data stream and to identify the preconfigured movements of the computer animated figures that correspond to the determined characteristics. The data visualization computer 102 can output the computer animated figures 112 to a display 110 to be seen by the user 104 and animate the figures 112 according to the preconfigured movements.

A data visualization computer 102 can be any combination of data storage and data processing apparatus capable of processing data streams, storing computer animated figures 112 and associated pre-choreographed movements, and animating and displaying the computer animated figures 112. A variety of devices can be suitable for this purpose. A computer 102 can be any general purpose or special purpose computing machine, and includes, by way of example only, desktop and laptop computers, high-performance graphics servers, PocketPCs, Blackberry devices, and other specialized hardware devices. The functions of the data visualization computer 102 can be distributed among several machines. For example, a personal computer or a laptop computer can be used as a fully integrated data visualization computer 102, where all of the functions, such as receiving and processing data streams and animating and displaying computer animated figures 112 can be performed on a single machine. As another example, a first machine, such as a desktop computer, can be used to receive and process the data streams to determine the characteristics, a second machine, such as a high-performance graphics server, can be used to identify movements associated with the characteristics and to perform animation operations, and third machine, such as a small form-factor portable computing device, can be used to display the animations to the user 104.

The data visualization computer 102 can also receive input from the user 104. The user 104 can use the visualization computer 102 to create, animate, and display computer animated figures 112 using any one of several commercially available computer graphics software packages used in web design and electronic gaming applications, such as Lightwave 3D by NewTek, Inc. of San Antonio, Tex., 3D Studio Max by Autodesk Media and Entertainment, Inc. of Montreal, Quebec, SoftImage XSI by Avid Technology, Inc. of Tewksbury, Mass., Alice created by Carnegie Mellon University, and Adobe Flash by Adobe Systems, Inc. of San Jose, Calif., to name a few. The data visualization computer 102 can store the computer animated figures 112 in a data store. The data store can be internal or external to the data visualization computer 102 and can be connected over a network 108.

The data visualization computer 102 can also provide an interface for choreographing the movements of the computer animated figures 112 as well as associating those movements with data characteristics of a data stream. The movements can be input using a movement notation application that can notate or capture specific forms of movement using a dance notation system, such as the Labanotation system or the Sutton Movement Writing system. Various commercially available editors can be used to input movement notations, such as Labanwriter developed by the Ohio State Department of Dance at the Ohio State University, CALABAN developed by The University of Birmingham in the United Kingdom, LED and Linter available at “http://www-staff.mcs.uts.edu.au/˜don/pubs/led.html” as of Aug. 12, 2008, Labanatory. The data visualization computer 102 can store the movements as well as an association of movements with certain data characteristics of a data stream. The associations can be created and stored with entries in tables, files, and/or databases that reference the set of movements and the description of the associated characteristics. The user interface functionality can be distributed, for example, with a specialized graphics machine used to create the animations and a second general purpose machine used to input the choreographed movements.

The data visualization computer 102 can include a network interface card that allows it to receive data streams from the network 108. The data visualization computer 102 can process a data stream and determine the data stream's characteristics. The types of characteristics that can be determined and monitored by the data visualization computer 102 are numerous and can depend on the type of data that is in the data stream. For example, a network monitoring system can be used to generate a data stream that contains information about the network traffic that the system is examining. Such information may include, for example, the volume of network traffic or number of packets received in a given amount of time, the average size of the received packets, and the amount of CPU utilization for processing the incoming packets.

Based on the information in the data stream, other information about the data stream can be determined. For example, a running average of the network traffic volume can be calculated as data is received or the peak volume can be determined. Other statistical properties and higher moments of the distribution functions can be determined, such as the standard deviation, the kurtosis, and the skewness of the data. These statistical properties and other data characteristics can be monitored and associated with movements of computer animated figures 112. For example, a data characteristic may be whether the data stream indicates a CPU utilization that exceeds a predefined threshold, such as 70% or two standard deviations from the median. This characteristic can be associated with a particular set of movements, such as waving the arms in a back and forth rhythmic movement. As the data visualization computer 102 processes the incoming data stream, the computer 102 can process the data to determine whether the CPU utilization threshold has been exceeded. Another characteristic can be the actual data itself, such as the traffic volume.

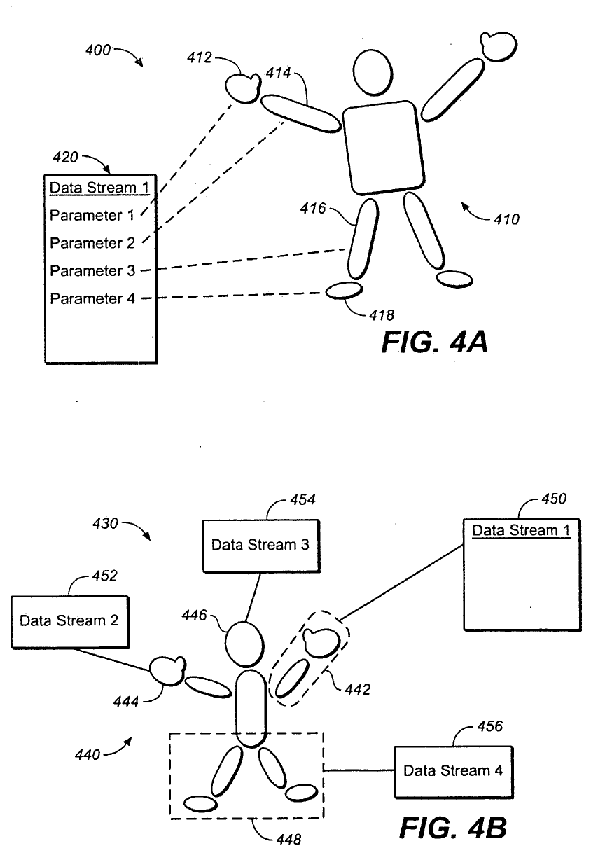

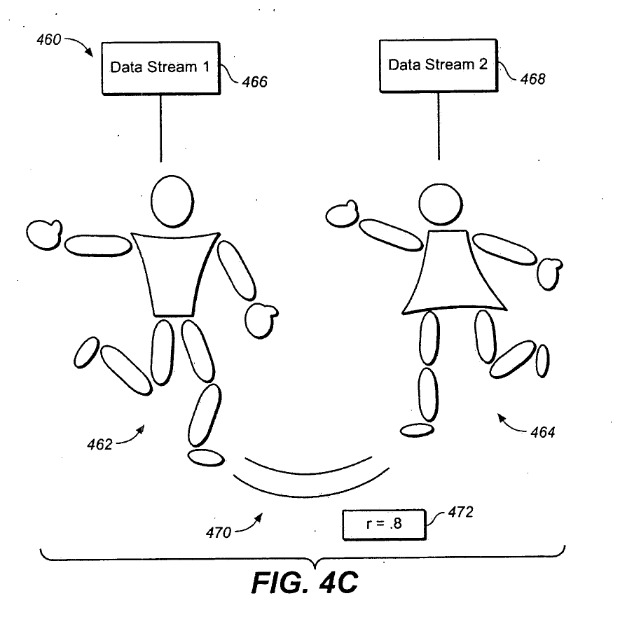

Movements can be associated with the traffic volume, such as, for example, the tempo of the movements increase as the volume increases or decrease as the volume decreases. When the data characteristics involve actual data values or the actual values of derived statistical properties, the animation can involve scaling the actual value and modifying the tempo, intensity or other attribute of movement according to the scaled actual value. For example, if the data stream includes a stream of data values for pressure in kilopascals (kPa), then a data value received in the data stream in the amount of 200 may be scaled by an appropriate factor and directly used to determine the tempo at which the computer animated figure dances. A higher pressure can result in a faster dance tempo. An observer watching the dancing animated figure can detect a sudden change in pressure by noticing that the animated figure is dancing much faster or much slower. The combination of characteristics that can be monitored and their associated response movements are numerous. FIGS. 4A-4C provide just a few examples.

FIG. 4A is an example association 400 showing a computer animated figure 410 that is animated in response to a single multivariate data stream 420. The computer animated figure 410 can include multiple body parts such as a head, hands 412, arms 414, legs 416, and feet 418. Each of these body parts can exhibit synchronized movement or move independently depending on the preference of the choreographer. The movements can be selected and defined so as to convey as much information as possible to an observer by using movements that intuitively relate to the type of information that is being conveyed. For example, data in a data stream that varies wildly and unexpectedly may be associated with a set of dance movements that is wild and unexpected.

Different characteristics of the data that is contained in the multivariate data stream 420 can be used to move different parts of the body. For example, the movements of the hands 412 can be used to describe CPU utilization with respect to packet size, arm movement 414 can be associated with CPU utilization with respect to actual traffic volume, leg movement 416 can be associated with CPU utilization with respect to the average volume over a certain period of time, and feet movement 418 can be associated with CPU utilization with respect to peak volume over a certain period of time. Data visualization of the CPU utilization with respect to different network parameters can be accomplished using a single computer animated figure 410.

FIG. 4B is an example association 430 showing a computer animated figure 440 with multiple limbs (at 442-448) moving in response to multiple data streams (at 450-456). Multiple data streams can be viewed using a single figure, even where the data streams are unrelated. For example, data stream 450 can be associated with the operational data related to a collection of solar panels that are used to provide auxiliary power to non-essential offices of a nuclear power plant. Data streams 452, 454, and 456 can be associated with other more critical parts of the nuclear power plant, such as water pressure, radiation levels, and the like. Each data stream can be associated with a limb or set of limbs. For example, data stream 450 can cause movements in only the left hand and data stream 456 can cause movements in all of the lower body 448. In some cases, the data streams can be independent of one another, but the computer animated figure 440 can be used to show a similar characteristic associated with each of the data streams. For example, the computer animated figure 440 can be used to show when data, no matter the source, has exceeded two standard deviations, and thus dance movements in the figure 440 would indicate that something out of the ordinary has occurred in the system.

FIG. 4C is an example association 460 showing multiple computer animated figures 462 and 464 being animated in response to multiple data streams 466 and 468. Each data stream can be associated with a single computer animated figure. The figures 462 and 464 can be choreographed independently of each other. The figures 462 and 464 can also be choreographed in such a way that a correlation 472 (commonly measured by a Pearson Product Moment Correlation Coefficient that is normally referred to as r) between the two is also visually depicted. Thus, a relationship between two seemingly unrelated data streams 466 and 468 that are highly correlated can be demonstrated by having the figures 462 and 464 dance in proximity to or in step with each other (at 470). If three computer animated figures are present on a single screen, for example, where two have a high correlation and the other does not, then the two correlated figures can dance together executing a “dos-a-dos” or inside partner step, while the third is off to the side. Where all three are correlated with each other, the three can be choreographed to dance together, performing, for example, the “Electric Slide” line dance.

Turning back to FIG. 1, a data source 106 transmits data streams to data visualization computer 102. A data source 106 can be a data store, one or more computers, a sensor, or any other device capable of collecting and transmitting data in a data stream. A data stream can contain single or multivariate parameterized data. Data is commonly parameterized by time (e.g., time series data), but can be parameterized by any useful variable such as time, height, length, intensity, temperature, pressure, depth, etc. The streams of data can originate from sensors, real-time structured and un-structured data, marketing analysis, or may be the outputs of forecasting calculations.

The data source 106 can include a network communications capability such that the data stream can be transmitted over a network 108. Because virtually any type of data can be visualized, the types of data sources 106 are numerous. For example, a data source 106 can be a data mining application that has captured enterprise wide data on electricity usage, which can be used to identify trends that can be used to negotiate better utility rates. Multiple data sources 106 can be coupled together to create a single data stream. For example, the data source 106 can be a collection of sensors used to collect the temperature of oceanic water to predict the path of hurricanes that provide position, time/date, and temperature in a single data stream. The data sources 106 can be incorporated into data visualization computer 102, such as, for example, in applications where the data has been previously generated and is undergoing analysis as in the data mining example.

Network 108 can be a packet switched Internet Protocol (IP) based network primarily used to communicate data. The network 108 can be, include, or otherwise communicate with wireless and/or wired personal, local, metropolitan, regional and/or wide area networks, and/or the Internet. Examples of wireless networks include networks conforming to Institute of Electrical and Electronics Engineers (IEEE) 802.11 related standards and/or IEEE 802.16 related standards (Wireless Metropolitan Area Networks). The data visualization computer 102 can use the network 108 to receive transmitted data from data sources 106.

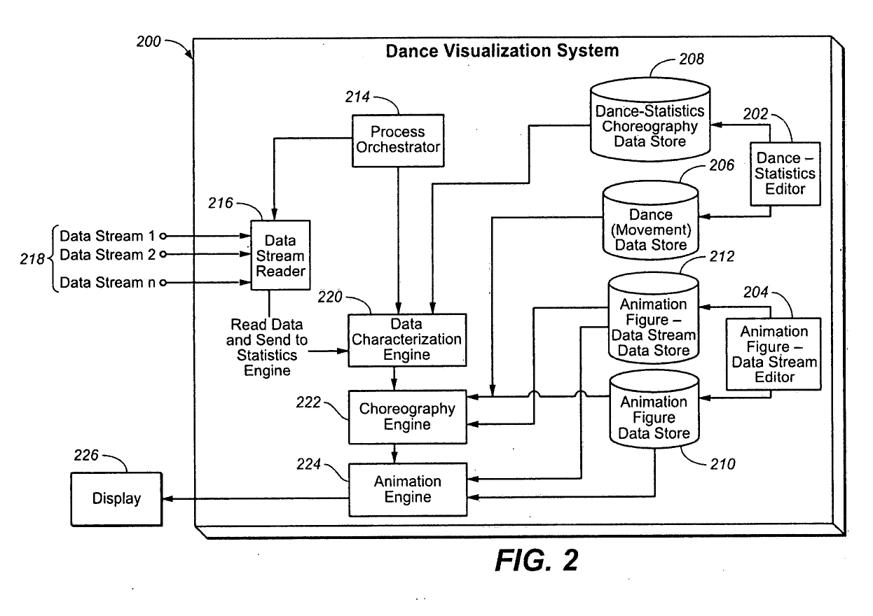

FIG. 2 is a block diagram of a data visualization system 200. The data visualization system 200 generally includes editors 202 and 204 used to create animated figures and dance movements and to assign the figures and movements to data streams and statistical properties of the data streams. Data characterization engine 220 processes incoming data streams 218 to monitor the statistics related to the data stream. The choreography engine 222 determines the animation figure associated with the data stream, and retrieves the dance movements assigned to the statistics. The animation engine 224 animates the figure according to the retrieved dance movements and outputs the computer animation to the display 226.

The dance-statistics editor 202 provides a user with the ability to create dance movements and to assign them to statistics of the data stream. The editor can include a graphical user interface that presents multiple data streams and allows the user to select a data stream for which to create choreography. The user interface, based on the selected data stream, can also provide a list of characteristics that can be monitored for the data stream, such as certain statistical properties associated with the data stream. The characteristics of the data stream can be metadata derived from the actual data in the data stream or can be the actual data contained in the data stream. Using a data stream containing time series temperature data, for example, a user can select to monitor the actual temperature contained in the data stream or can select the mean temperature. The monitored characteristic can also be whether a certain condition exists within the data. For example, the monitored characteristic can be whether the average temperature exceeds 200 degrees Fahrenheit or whether the temperature has exceeded three standard deviations from the running average temperature. A monitored characteristic of the data stream can be any combination of these as well as other characteristics, such as the frequency with which data is received in the data stream. Using the user interface, a monitored characteristic can be assigned to dance movements that will be performed or executed when the monitored characteristic is present in the data stream. The assignment or association can be stored in the dance-statistics choreography data store 208.

Dance movements are generally aesthetically pleasing rhythmic motions and gestures. Dance movements can be captured by using a dance notation system, such as Labanotation or any other suitable dance and movement notation system that is amenable to processing by a digital computing device. When the Sutton Movement system is used, movements describing skate-boarding, pantomime, gymnastics, and other such activities can be used. The user interface of the dance statistics editor can provide a user or choreographer an interface for inputting the dance notation into the system 200. The movements once created can be stored in the dance movement data store 206. Several movements can be pre-stored or downloaded into the dance movement data store 206 without the user having to create them.

Animation figure-data stream editor 204 provides the user with the ability to create animation figures and to associate them with data streams. The editor can include a graphical user interface that presents multiple data streams and allows the user to select a data stream for which to associate an animation figure. The user can be presented with a pictured list of the available animation figures from which to select or can be allowed to create an animation figure. The selected animation figure can be associated with the data stream by storing the relationship in the animation figure-data stream data store 212. The user interface can provide a mechanism for the user to create the animation figure. A distinct animation figure can be created for each data stream. The figures can differ in color, shape, and size, which can visually indicate each distinct data stream being visualized. Animation figures can be made to be as complex as the user desires. Animation figures once created can be stored in the animation figure data store 210 for subsequent retrieval. Several animation figures can be pre-stored or downloaded into the animation figure data store 210 without the user having to create them.

The associations stored in the data store (at 206, 208, 210, and 212) can be used to visualize data streams 218. The process orchestrator 214 can be used to start the process of monitoring data streams 218 by directing the data stream read 216 to receive data and directing the data characterization engine 220 to start processing the read data streams 218.

The data characterization engine 220 can receive and process the data stream. The data characterization engine 220 can read the dance-statistics choreography data store 208 to determine which characteristics to monitor for the received data stream(s). The statistical properties of data streams, such as median, mean, standard-deviation, and other moments of the distribution function can be automatically computed. The data characterization engine 220 can be used to monitor the statistical properties and/or other monitored characteristics. In other words, the statistics engine is used to characterize the statistical properties of the data streams. However, it also serves to monitor other data characteristics such as thresholds and frequency.

The choreography engine 222 can retrieve the dance movements assigned to or associated with the monitored characteristics from dance movement data store 206. The choreography engine 222, using animation figure-data stream data store 212, can also identify the animation figure that is associated with the received data stream and retrieve the animation figure or a reference to it from the animation figure data store 210. The animation engine 224 can perform graphics calculations based on the retrieved dance movements and the animation figure in order to generate and display the moving animation figure on the display 226. The functions associated with the various engines can be fully or partially automated.

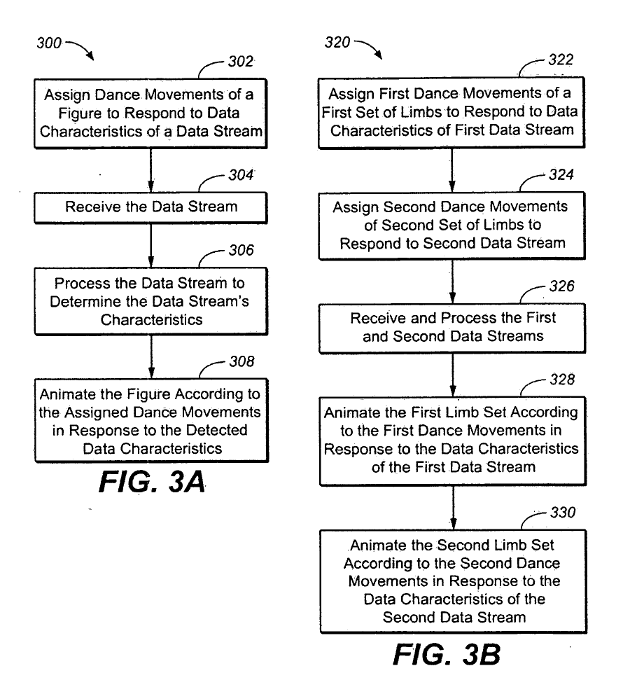

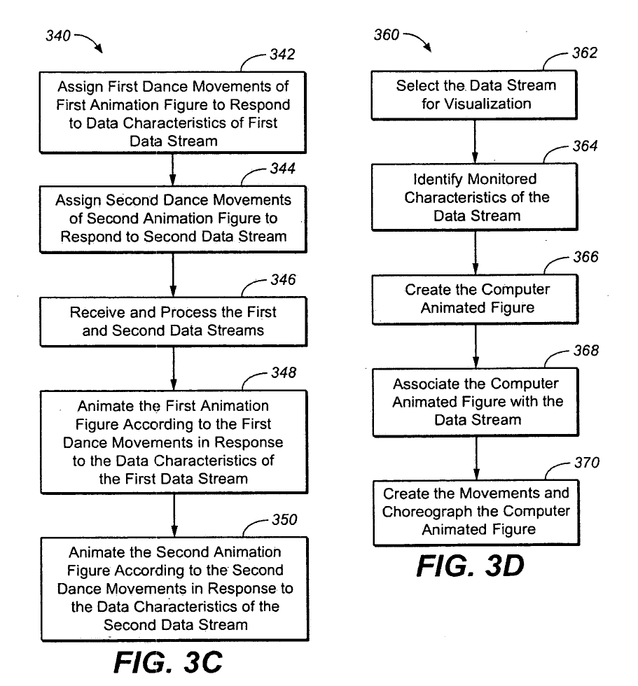

FIG. 3A is a flowchart of a process 300 for data visualization using computer animated figure movement. At 302, dance movements are assigned to characteristics of a data stream. The dance movements can be defined using a dance notation system. There are several dance and movement notation systems that can be used. Some movement notation systems involve forms of movement that are not typically associated with dance and can be used just as dance notation systems. The characteristics can be the actual data in the data stream or information about the actual data, which can include statistical properties of the data and whether the actual data or statistical properties meet certain conditions such as exceeding or falling below a threshold. Statistical properties include, but are not limited to, mean, standard deviation, variance, kurtosis, skewness and other higher moments about the mean, mode, median, minimum, maximum, and correlations, to name a few. A set of dance or other movements can be assigned to a set of characteristics, such that an animation figure is animated according to the set of movements in response to the set of characteristics.

The data stream is received at 304 and processed at 306 to determine the characteristics of the data stream. The characteristics that have corresponding or assigned movements can be determined without determining other characteristics that do not have assigned movements. For example, if movements are assigned to respond only to the actual data as opposed to information about the actual data in the data stream, statistical properties may not have to be determined for the data stream. At 308, the figure that is associated with the data stream is animated. The dance movements assigned to the characteristics that were present in the data stream can be performed by the computer animated figure on a display.

FIG. 3B is a flowchart of a process 320 for visualizing two data streams using two limbs of a computer animated figure. At 322, a first set of dance movements associated with a first set of limbs can be assigned to characteristics of a first data stream. Limbs of an animated figure can include hands, arms, legs, feet, fingers and toes, as well as a neck, head, and torso. In fact, any portion of an animated figure that can be separately animated can be considered a limb. At 324, a second set of dance movements can be associated with a second set of limbs and second data stream. At 326, the first and second data streams are received and processed. In addition to reading the data values in the data stream, the processing can involve calculating statistical properties and/or deriving other information or metadata related to the data stream. Specifically, the characteristics that have assigned dance movements can be determined from the first and second data streams. The computer animated figure is animated at 328 and 330. At 328, the first set of limbs is animated according to the first set of dance movements. At 330, the second set of limbs is animated according to the second set of dance movements. The animation can involve increasing the intensity or tempo of the set of dance movements in response to the monitored characteristic. For example, when the characteristic is related to exceeding a threshold value, a jump can be higher when a data value far exceeds the threshold value and be lower when the data value barely exceeds the threshold value.

FIG. 3C is a flowchart of a process 340 for visualizing two data streams using two computer animated figures. At 342, the first set of dance movements can be assigned to data characteristics of the first data stream, which can be associated with the first animation figure. At 344, the second set of dance movements can be assigned to data characteristics of the second data stream, which can be associated with the second animation figure. A third set of dance movements can also be assigned where there is a high correlation between the first and second data streams. The third set can allow the animated figures to dance together in close proximity and/or synchronized to visually demonstrate the high correlation. At 346, the first and second data streams can be received and processed. In processing the data streams, a correlation between the two data streams can be determined.

At 348, the first animation figure can be animated according to the first set of dance movements. At 350, the second animation figure can be animated according to the second set of dance movements. Also, if the two data streams are highly correlated and the third set of dance movements is assigned to the high correlation, then the two animated figures can dance according to the third set. The third set of movements can override the first and second sets of dance movements for the two figures. The third set of movements can be blended with the first and second sets of dance movements such that both the monitored characteristics of the first and second data streams and the correlation between the two data streams are communicated to an observer. Alternatively, a special relationship between the two animated figures can be defined to express the correlation of the two data streams. For example, the special relationship may be to display the two figures proximately when the correlation between the two is high. The spatial relationship can also be that the two figures dance around each other with a certain rhythm.

FIG. 3D is a flowchart of a process 360 for choreographing a computer animated figure for visualizing a data stream. At 362, a user selects the data stream for visualization. The data stream can be selected from a user interface that displays the possible data streams. At 364, characteristics to be monitored in the data stream can be identified. The characteristics can include actual data, statistical properties about the data, other metadata, and any combination of these. At 366, the computer animated figure can be created. The user can create the animated figure from scratch using a user interface or based on one that has been previously created. At 368, the computer animated figure can be associated with the selected data stream. At 370, the user can create movements using movement and dance notation, and assign the movements to the monitored characteristics. The movements can be used later to animate the computer animated figure in response to processing the associated data stream and determining the monitored characteristics. That is, as the data stream is processed, the system can monitor the characteristics that have movements assigned to them and animate the computer animated figure in response to the presence of the monitored characteristics.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments of the invention have been described. Nevertheless, it will be understood that various modifications may be made without departing from the spirit and scope of the invention. For example, a request for a particular publication material can be initiated by prompting the user to select from a list of available titles. Accordingly, other embodiments are within the scope of the following claims.

What is claimed is:

1. A method comprising:
associating a computer animated figure with a data stream;
assigning a set of movements to be performed by the computer animated figure in response to one or more data characteristics of the data stream;
receiving the data stream;
identifying data characteristics in the data stream; and
animating the computer animated figure according to the assigned set of movements in response to the identified data characteristics.

2. The method of claim 1, wherein the set of movements comprises a set of dance movements and assigning the set of movements comprises assigning the set of dance movements using a dance notation system.

3. The method of claim 1, wherein assigning a set of movements comprises assigning the set of movements using a movement notation system, the movement notation system comprising one of: a Labanotation system or a Sutton Movement system.

4. The method of claim 1, wherein the one or more data characteristics comprise one or more statistical properties associated with at least a portion of the data stream, the one or more statistical properties comprising at least one of: a mean, a standard deviation, a variance, a kurtosis, a skewness, a minimum, or a maximum.

5. The method of claim 4, wherein assigning a set of movements comprises assigning a set of movements to be performed by the computer animated figure in response to a first statistical property of the one or more statistical properties exceeding a predetermined threshold; processing the data stream comprises processing the data stream to determine whether the first statistical property exceeds the predetermined threshold; and animating the computer animated figure comprises animating a computer animated figure according to the assigned set of movements in response to determining that the first statistical property exceeds the predetermined threshold.

6. The method of claim 1, wherein:
the one or more data characteristics comprise data values in the data stream;
assigning a set of movements comprises assigning a set of movements to be performed by the computer animated figure in response to the data values;
identifying data characteristics comprises processing the data stream to determine the data values; and
animating the computer animated figure comprises animating a computer animated figure according to the assigned set of movements in response to the data values.

7. The method of claim 6, wherein animating the computer animated figure comprises modifying a speed associated with movements of the computer animated figure in response to changes in the data values.

8. The method of claim 1, wherein the data stream comprises a first data stream and a second data stream, and the computer animated figure comprises a plurality of limbs, the method further comprising:
assigning a first set of movements of a first set of limbs of the plurality of limbs to be performed by the computer animated figure in response to one or more data characteristics of the first data stream;
assigning a second set of movements of a second set of limbs of the plurality of limbs to be performed by the computer animated figure in response to one or more data characteristics of a second data stream;
receiving the first data stream;
receiving the second data stream;
identifying one or more data characteristics of the first data stream;
animating the first set of limbs according to the assigned first set of movements in response to the one or more identified data characteristics of the first data stream;
identifying one or more data characteristics of the second data stream; and
animating the second set of limbs according to the assigned second set of movements in response to the one or more identified data characteristics of the second data stream.

9. The method of claim 1, wherein the data stream comprises a first data stream, and the computer animated figure comprises a first computer animated figure, the method further comprising:
assigning a second set of movements to be performed by the second computer animated figure in response to one or more data characteristics of the second data stream;
receiving the second data stream;
identifying one or more data characteristics of the second data stream; and
animating the second computer animated figure according to the assigned second set of movements in response to the identified one or more data characteristics of the second data stream.

10. The method of claim 9, further comprising:
determining a correlation between the first data stream and the second data stream;
associating a spatial relationship between the first computer animated figure and the second computer animated figure corresponding to the correlation; and
animating the first computer animated figure and the second computer animated figure in accordance with the spatial relationship.

11. The method of claim 10, wherein the first data stream and the second data stream are highly correlated, and the spatial relationship comprises at least one of: the first computer animated figure moving in relatively close proximity to the second computer animated figure and the first computer figure moving with approximately the same rhythm as the second computer figure.

12. The method of claim 1, further comprising providing a user interface, the user interface operable to accept input from a user to:
select the data stream for visualization;
receive an identification of one or more data characteristics;
create the computer animated figure;
associate the computer animated figure with the data stream;
identify the set of movements using a movement notation system; and
choreograph the computer animated figure by associating the one or more data characteristics with the set of movements.

13. A system comprising:
a memory adapted to store:
one or more computer animated figures;
data defining a set of movements to be performed by a computer animated figure in response to data characteristics of the data stream;
one or more data processing apparatuses operable to interact with the memory and to perform operations comprising:
receiving the data stream;
processing the data stream to identify one or more data characteristics; and
animating a selected computer animated figure according to the data defining a set of movements in response to the identified one or more data characteristics.

14. The system of claim 13, wherein assigning a set of movements comprises assigning the set of movements using a movement notation system, the movement notation system comprising one of: a Labanotation system or a Sutton Movement system.

15. The system of claim 13, wherein the one or more data characteristics comprise one or more statistical properties associated with at least a portion of the data stream, the one or more statistical properties comprising at least one of: a mean, a standard deviation, a variance, a kurtosis, a skewness, a minimum, or a maximum.

16. The system of claim 15, wherein the data defining a set of movements comprises data defining a set of movements to be performed by the computer animated figure in response to a first statistical property of the one or more statistical properties exceeding a predetermined threshold; processing the data stream comprises processing the data stream to determine whether the first statistical property exceeds the predetermined threshold; and animating the selected computer animated figure comprises animating the selected computer animated figure according to the data defining a set of movements in response to determining that the first statistical property exceeds the predetermined threshold.

17. The system of claim 13, wherein the data stream comprises a first data stream and a second data stream, and the computer animated figure comprises a first computer animated figure, the data defining a set of movements comprising:
a first set of movements to be performed by the first computer animated figure in response to one or more data characteristics of the first data stream;
a second set of movements to be performed by the second computer animated figure in response to one or more data characteristics of the second data stream; and
the operations further comprising:
receiving the second data stream;
processing the second data stream to identify one or more data characteristics of the second data stream; and
animating the second computer animated figure according to the assigned second set of movements based on the one or more identified data characteristics of the second data stream.

18. The system of claim 17, the operations further comprising:
determining a correlation between the first data stream and the second data stream;
associating a spatial relationship between the first computer animated figure and the second computer animated figure corresponding to the correlation; and
animating the first computer animated figure and the second computer animated figure in accordance with the spatial relationship.

19. The system of claim 13, further comprising:
a user interface operable to accept input from a user to:
select the data stream for visualization;
associate the computer animated figure with the data stream;
identify the set of movements using a movement notation system; and
choreograph the computer animated figure by associating the one or more data characteristics with the set of movements.

20. A computer program product, encoded on a computer-readable medium, operable to cause data processing apparatus to perform operations comprising:
receiving a data stream;
processing the data stream to identify one or more data characteristics; and
animating a computer animated figure associated with the data stream according to a set of movements assigned to be performed in response to particular data characteristics of the data stream in response to the identified one or more data characteristics.

21. The product of claim 20, wherein assigning a set of movements comprises assigning the set of movements using a movement notation system, the movement notation system comprising one of: a Labanotation system or a Sutton Movement system.

22. The product of claim 20, wherein the one or more data characteristics comprise one or more statistical properties associated with at least a portion of the data stream, the one or more statistical properties comprising at least one of: a mean, a standard deviation, a variance, a kurtosis, a skewness, minimum, or a maximum.

23. The product of claim 22, wherein the set of movements comprises a set of movements to be performed by the computer animated figure in response to a first statistical property of the one or more statistical properties exceeding a predetermined threshold; processing the data stream comprises processing the data stream to determine whether the first statistical property exceeds the predetermined threshold; and animating the computer animated figure comprises animating a computer animated figure according to the at least one movement in the set of movements in response to determining that the first statistical property exceeds the predetermined threshold.

24. The product of claim 20, wherein:
the data stream comprises a first data stream, and the computer animated figure comprises a first computer animated figure, the computer program product, encoded on a computer-readable medium, further operable to cause data processing apparatus to perform operations comprising:
receiving the second data stream;
processing the second data stream to identify one or more data characteristics of the second data stream; and
animating the second computer animated figure according to an assigned second set of movements to be performed by the second computer animated figure in response to one or more data characteristics of the second data stream, wherein the second computer animated figure is animated in response to the one or more identified data characteristics of the second data stream.

25. The product of claim 24, wherein the computer program product is further operable to cause data processing apparatus to perform operations comprising:
determining a correlation between the first data stream and the second data stream;
associating a spatial relationship between the first computer animated figure and the second computer animated figure corresponding to the correlation; and
animating the first computer animated figure and the second computer animated figure in accordance with the spatial relationship.

26. The product of claim 25, wherein the first data stream and the second data stream are highly correlated, and the spatial relationship comprises at least one of: the first computer animated figure moving in relatively close proximity to the second computer animated figure and the first computer figure moving with approximately the same rhythm as the second computer figure.

27. The product of claim 20, further comprising providing a user interface, the user interface operable to accept input from a user to:
select a data stream for visualization;
define the particular data characteristics;
select a computer animated figure to be associated with the data stream;
identify the set of movements using a movement notation system; and
choreograph the computer animated figure by associating the particular data characteristics with the set of movements.
